(19) United States
(12) Patent Application Publication
(10) Pub. No.: US 2010/0107872 A1
(43) Pub. Date: May 6, 2010

(54) BIOGAS UPGRADING

(76) Inventor: Warwick James Bethell, Auckland (NZ)

Correspondence Address: JACOBSON HOLMAN PLLC, 400 SEVENTH STREET N.W., SUITE 600, WASHINGTON, DC, 20004, US

(21) Appl. No.: 12/450,304

(22) PCT Filed: Mar. 6, 2008
(86) PCT No.: PCT/NZ2008/000043

§ 371 Date: Oct. 14, 2009

(30) Foreign Application Priority Data
Mar. 20, 2007 (NZ) 553992

(51) Int. Cl. B01D 53/26; B01D 53/04; B01D 53/14

(52) U.S. Cl. 95/92; 96/134; 96/130

(57) ABSTRACT

A process and apparatus for treating a biogas stream. The treatment is both to increase methane content and reduce H₂S content, said process comprising at least,
(i) taking a biogas stream having both a methane and carbon dioxide content and including an H₂S content,
(ii) scrubbing the stream (with or without prior modification, e.g. any one or more of compression, partition, stripping, flashing, recycle in part, etc.),
(iii) drying the wet stream from step (ii) stream, and
(iv) removing H₂S from step (iii) stream to a level below 0.005%.

### FIELD OF THE INVENTION

The present invention relates to the purification of biogas, such as that prepared by anaerobic digestion of waste material.

### BACKGROUND TO THE INVENTION

Biogas is produced by the anaerobic digestion or fermentation of wastewaters and solid residues. The material digested can include organic matter such as manure, sewage sludge, biodegradable waste or any other biodegradable feedstock.

The process is essentially the degradation of organic compounds in the absence of oxygen to produce a saturated gas mixture mainly of methane, carbon dioxide and hydrogen sulphide.

Before biogas can be used as fuel for vehicles it must be “upgraded” or enriched in methane to become bio-methane. Removal of most of the carbon dioxide raises the methane content sufficiently. Furthermore, the gas needs to be dried and hydrogen sulphide removed. In Sweden bio-methane has been used as a fuel since the early 1990s. The industry standard for bio-methane for vehicle fuel is the Swedish standard SS 15 54 38—Standards A and B.

TABLE 1
Excerpt from the Swedish Standard for
biogas as vehicle fuel (SS 15 54 38)

| Component | Unit | Standard A | Standard B |
|---|---|---|---|
| Methane, CH₄ | Vol-% | 96-98 | 95-99 |
| Water content | Mg/Nm³ | <32 | <32 |
| Oxygen, O₂ | Vol-% | <1 | <1 |
| Total sulphur | Mg/Nm³ | <23 | <23 |

We are particularly interested in the removal of hydrogen sulphide from biogas. Hydrogen sulphide is harmful to humans and animals. At lower concentrations the gas has an unpleasant odour. At higher concentrations it can present a threat to life.

Hydrogen sulphide in fuel gas is detrimental to metallic engine components and high pressure storage vessels due to its corrosive effect, especially in the presence of water. Hydrogen sulphide also has detrimental environmental effects including the formation of acid rain, when released via a vehicles exhaust.

Biogas upgrading is essentially any process which is capable of separating biogas into its constituent gases. Various techniques exist, the more relevant of which are outlined below.

“Water scrubbing” involves passing the biogas stream through an absorber or scrubber packed with media to provide a high contact surface area at a gas/water interface.

The biogas is brought into contact with water at elevated pressure; components of the biogas are absorbed into the water until saturation equilibrium reached. The gas which is not absorbed is discharged from the scrubber. This discharged gas is enriched in methane but also contains residual traces of hydrogen sulphide and carbon dioxide. This discharged gas is saturated with water.

Typical approximate contents are:
97%-99% methane,
1%-2.5% carbon dioxide,
0.5% insoluble contaminants: (oxygen and nitrogen from the air dissolved in the scrubbing water or air contamination of the raw biogas stream),
5 PPM hydrogen sulphide,
Water vapour

The discharge gas remains unsuitable for immediate use due to its water saturation. Thus it is usually put through a drying process to remove water.

Draw backs to the water scrub process include clogging of packing due to the growth of bacteria, and the formation of elemental sulphur, especially when incoming biogas has a high level hydrogen sulphide in it.

“Polyethylene glycol scrubbing” is similar to water scrubbing. However there is a significantly higher propensity for the absorption of hydrogen sulphide and carbon dioxide. Therefore there is less demand for recirculation of the solvent, and the pumping costs are lower. However, as the polyethylene glycol scrubbing solution is regenerated by heating, energy costs may be higher than in other techniques.

“Pressure Swing Adsorption” (PSA) is an alternative technique used to separate carbon dioxide from biogas to increase the methane content. PSA separates particular species from a gas under pressure according to those species' molecular sizes. Porous materials are used as molecular sieves, such as zeolites. PSA works by adsorbing at one pressure, and then lowering the pressure to desorb gas from the porous materials.

Various problems exist with PSA including:
Poisoning—where the porous media may become permanently saturated with a contaminant such as hydrogen sulphide, preventing its regeneration.
Disposal of media—at the end of the useful life, or after poisoning the porous media needs to be replaced creating a disposal issue for the used media.
Methane Loss—Methane gas losses to atmosphere are higher than those produced by the water scrub technique. This is considered a negative due to the higher propensity of methane to act as a greenhouse gas than carbon dioxide.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### OBJECT OF THE INVENTION

It is an object of the present invention to provide an alternative or improved means of upgrading biogas to those currently available. It is an alternative object to overcome at least one of the abovementioned disadvantages.

### SUMMARY OF THE INVENTION

According to a first aspect of the invention there is provided a process for increasing the concentration of methane gas (CH₄) in a biogas stream comprising
i) wet scrubbing the biogas stream,
ii) drying the biogas stream and)
iii) removing hydrogen sulphide (H₂S), or at least some of the H₂S, from the biogas stream,

wherein the step of removal of the H₂S is subsequent (preferably immediately subsequent, i.e. without intervening processing) to the step of dehydration.

Preferably drying of the upgraded biogas stream comprises passage of the upgraded biogas stream through a porous material capable of removing water from the gas, and removal of H₂S comprises passage of the upgraded biogas stream through activated carbon, wherein the porous material and the activated carbon are located in a single vessel and the drying and H₂S removal steps are carried out by passage of the upgraded biogas through this vessel.

Preferably the porous material and the activated carbon are packed in a sequential fashion of porous material preceding the activated carbon in a single column (“the column”).

Preferably the porous material comprises molecular sieves.

Preferably the relative quantities of molecular sieves to activated carbon is selected so that regeneration of the molecular sieves is required at substantially the same or similar time to the activated carbon.

Preferably the wet scrubbing process is a water scrubbing process, preferably carried out in a water scrubber.

Preferably the upgraded biogas exiting the water scrubber is at a temperature between 2-10° C. Preferably the upgraded biogas entering the column is at a temperature between 2-10° C. upon entry.

Preferably upon exiting the column the H₂S levels of the upgraded biogas are in parts per billion.

Preferably upon exiting the column the produced bio-methane meets the Swedish standard for biogas SS 15 54 38; preferably standard A, more preferably standard B.

In another aspect the invention is a process for treating a biogas stream both to increase methane content and reduce H₂S content, said process comprising at least,

(i) taking a biogas stream having both a methane and carbon dioxide content and including an H₂S content,

(ii) scrubbing the stream (with or without prior modification, e.g. any one or more of compression, partition, stripping, flashing, recycle in part, etc.),

(iii) drying the wet stream from step (ii) stream, and

(iv) removing H₂S from step (iii) stream to a level below 0.005%.

Preferably at least step (ii) is at elevated pressure.

Preferably step (iv) involves passage through activated carbon.

Preferably step (iii) involves passage through a molecular sieve.

Preferably steps (iii) and (iv) are performed by a passage through a same vessel.

Preferably steps (iii) and (iv) are performed in sequence in a single vessel of a bank of at least two such vessels and the stream is diverted from one to the other as the content of a vessel degrades in use (e.g. by reference to the dew point of the output gas stream).

Broadly according to a further aspect of the invention there is provided apparatus for increasing the CH, content of a stream of biogas comprising a wet scrubber, and

a column (the column) containing (in order of passage of the stream therethrough) firstly a quantity of porous material capable of removing water from the stream; followed by a quantity of activated carbon:

Preferably the porous material comprises molecular sieves.

Preferably the relative quantities of molecular sieves to activated carbon is selected so that regeneration of the molecular sieves is required at substantially the same or similar time to the activated carbon.

Preferably the wet scrubber is a water scrubber.

Preferably the apparatus includes two substantially identical columns arranged in parallel, allowing one column to be on line whilst the other column is regenerated.

Preferably the apparatus includes means to separate a fraction of the upgraded biogas exiting the on-line column, heating of that fraction of gas, and passage of that fraction of gas in a counter current direction through the column being regenerated.

According to a further aspect of the invention there is provided biogas enriched in methane and/or reduced in H₂S prepared according to the above method and/or prepared by passage through the above apparatus.

Preferably the produced bio-methane meets the Swedish standard for biogas SS 15 54 38; preferably standard A, more preferably standard B.

According to a further aspect of the invention there is provided a column for increasing the CH₄ content and/or reducing the H₂S of a stream of biogas (preferably scrubbed or water including) comprising a column packed sequentially with a gas dehydrating porous material followed by activated carbon.

Preferably the dehydrating porous material is molecular sieves.

Preferably the relative quantities of molecular sieves to activated carbon is selected so that regeneration of the molecular sieves is required at substantially the same or similar time to the activated carbon.

Other aspects of the invention may become apparent from the following description which is given by way of example only and with reference to the accompanying drawings.

The term “comprising” as used in this specification means “consisting at least in part of”. When interpreting statements in this specification which include that term, the features, prefaced by that term in each statement all need to be present, but other features can also be present. Related terms such as “comprise” and “comprised” are to be interpreted in the same manner.

The term “activated carbon” as used in this specification also includes the terms activated charcoal or activated coal.

The term “molecular sieves” refers to materials containing tiny pores of a precise and uniform size that is used as an absorbent for gases and liquids. These are often aluminosilicate materials but we are not restricted only to aluminosilicates.

The term “and/or” means either “and” or “or”; or, where the context allows, both.

### BRIEF DESCRIPTION OF THE DRAWINGS

The invention will now be described by way of example only and with reference to the drawings in which:

FIG. 1: Schematic illustration of a column used to remove contaminants in accordance with the invention;

FIG. 2: Process flow diagram of one embodiment of the invention;

### DETAILED DESCRIPTION OF THE INVENTION

We have developed a process for the purification of biogas which reduces the levels of the impurities of a biogas feed. Raw biogas usually contains methane (CH₄) of around 65% carbon dioxide (CO₂) around 35% and other contaminants such as air, hydrogen sulphide (H₂S) and siloxanes.

Our invention is directed towards improved methane recovery and/or also to reducing the content of these other contaminants, and in preferred embodiments, particularly reducing the content of hydrogen sulphide.

### Biogas Upgrading

Our invention uses a three step process to reduce the impurity content and in preferred embodiments particularly the H₂S content.
a) a first process of wet (preferably water) scrubbing to remove predominantly H₂S and CO₂;
b) a second process of dehydration using molecular sieves or other equivalent materials;
c) a third process of further H₂S removal using activated carbon.

The key features of our process which render it inventive include at least one of that:
the process is a hybrid process of water scrubbing and PSA albeit in a non-obvious fashion, incorporating further steps;
the second and third processes are, unusually, carried out in a single column or location;
we get unusually high performance from our process in that levels of impurities (particularly H₂S) are significantly lower than what we have experienced previously.

### Water Scrubbing

The wet scrubbing process uses liquid to absorb the impurity gases from the biogas. We prefer to use water (i.e. water scrubbing) but alternatives to water can be used as is known in the art, such as amines or polyethylene glycol.

The scrubber operates at an elevated pressure to force gas absorption into water. The scrubber can operate at temperatures between just above 0° C. 30° C.; however we prefer to operate between 2-10° C. The scrubbing process upgrades the biogas quality by preferentially absorbing the undesirable gases, such as CO₂ and H₂S into the water.

Our preferred arrangement for water scrubbing is described below.

### Dehydration

Following our water scrubbing process the gas is then subject to a dehydration process, Using molecular sieve/porous materials as are known in the art. Type 4A and 13X molecular sieves are the common sieves used for water removal and are suitable here. They are able to remove water vapour and contaminants having a smaller critical diameter than 4A. However other suitable porous materials can be used as is well known by those skilled in the art.

Although drying of a gas stream using such materials is used in prior art biogas purification this has a number of unique features.

### Activated Carbon Removal of H₂S

The upgraded biogas is then further purified by passing through activated carbon. It is not at elevated temperature but at the temperature of the gas (substantially same as 2-10° C.). Activated carbon is known in the art to remove H₂S from gas systems. Any grade or brand or activated carbon capable of H₂S removal would be suitable.

### Dehydration and H₂S Removal in One Location

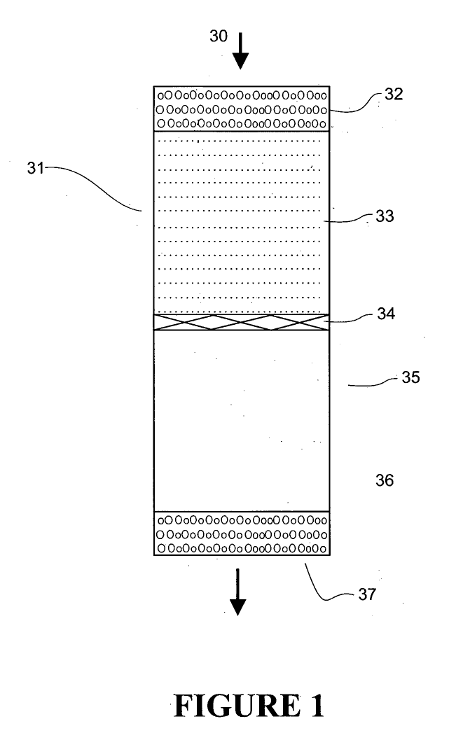

In our system we have devised a way that the dehydration column and activated charcoal bed can be housed in one location. The preferred form uses one column as illustrated in FIG. 1. In the preferred form of the process the upgraded biogas 30 enters the column 31 at one end, passes through a layer of the pebbles 32 acting as a course mesh to keep the contents in place, and then to the dehydration stage via molecular sieves 33. The column is constructed with a dividing mesh of stainless steel 34 between the molecular sieves 33 (again to keep the contents in place) and the following activated carbon 35. The purified gas passes through a final layer of pebbles 36, and out the distal end 37 of the column 31.

### ADVANTAGES OF THE INVENTION

The invention possesses at least one of the following novel features and/or advantages.

Firstly the gas entering the dehydration process has been cooled by passing through the preceding wet scrubbing step. In this case the temperature of the incoming gas is approximately at the same temperature as the water scrubber operating temperature, likely between 2-10° C. This is cooler than the gases purified by PSA processes in the prior art. The gas temperature upon entry to a PSA column is generally around 30° C. One significant advantage of our operating lower temperature is that the water content of the incoming biogas is lower than that of gas at ambient temperature. This is an advantage for our method as the column can be on line for a longer period before needing regeneration. We believe the gas make up on entry to the column has 0.07%-0.12% water (vol), around 2% CO, and around 1-5 ppm H₂S.

Secondly the proximity of the drying step to the following H₂S removal by activated carbon is unique.
i. we believe we are seeing a much greater degree of H₂S reduction than in the prior art we can deal with incoming gas streams having H₂S levels in the 500-2000 ppm levels Our levels of H₂S in our product gas are now parts per billion (ppb). After exiting the water scrubbing system, we see levels of less than 5 ppm but it is the positioning and conditions of the subsequent purification column process which give the vast improvement to parts per billion observed.
ii. We have a greater efficiency of design by placing the dehydration column in the same place as the activated charcoal bed.
iii. Our net capture of methane is greater than that observed from processes of the prior art. We see losses of 1% product or less whilst conventional PSA process to 5% of their product due to their regeneration system.

### Regeneration of the Column

The molecular sieves and the activated carbon require regeneration. This is generally brought about by depressurisation and heating.

In practice a plant utilising our process may have two columns 31 allowing one column to be taken off line to regenerate while the other remains on-line.

The regenerating column is depressurised back to suction pressure (around atmospheric pressure), heated until regenerated, cooled, then re-pressurised. Depressurisation and heating increases the H₂S volatility.

In one embodiment a fraction of the product gas is taken, heated and sent back through the off line column to bring about the regeneration. It is important to note that in column regeneration we avoid any exposure of the column to oxygen as this could be a hazard.

In our system, as we have a comparatively lowly saturated gas entering the column in the first place (in comparison to standard PSA processes) we have a longer on line time of between 8-24 hours for each column. One advantage of our system is that we match residence times of the two media in each column (molecular sieves and activated carbon)—in other words, we used proportions of the two different media such that the possible saturation time of the purification beds through any column is substantially the same before regeneration is required. This is a considerable advantage over the prior art where one bed, either the molecular sieve or the activated carbon, may become saturated before the other is saturated, thus forcing a regeneration cycle prematurely.

When a new column comes on line, we obtain a product gas with a dew point around −110° C. at the start. This increases as the time the column is on line increases. Our switch point from one column to the other is at a dew point of −85° C. The dew point needs to be low as the biogas after processing is compressed to high pressure (250 bar.g) as it is used as vehicle fuel. In freezing conditions the formation of water crystals, (ice) or methyl-hydrates is undesirable.

### Examples

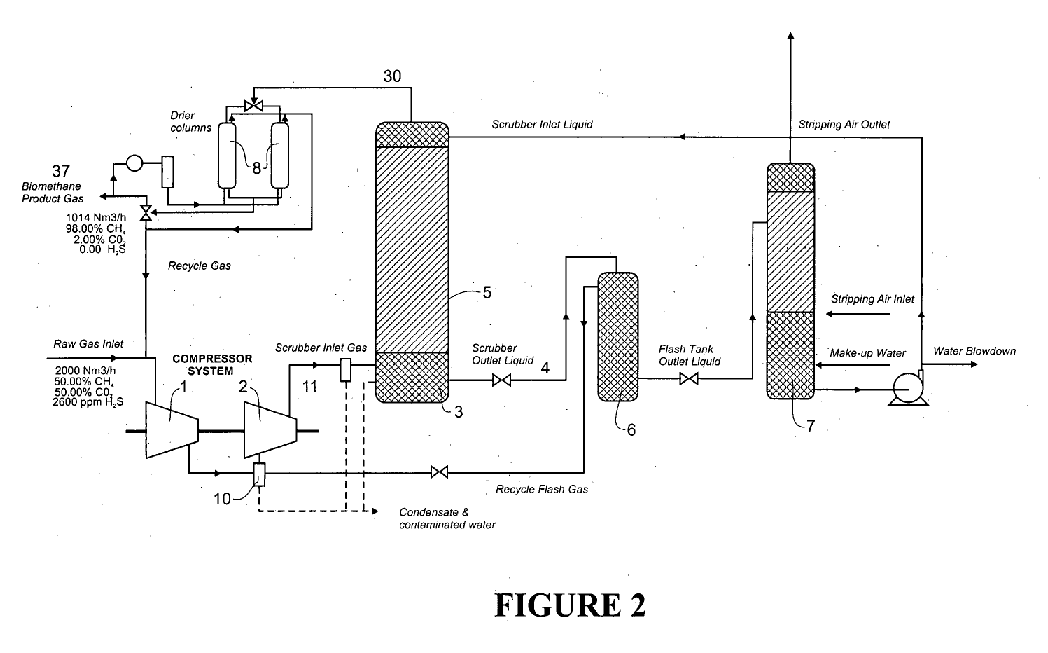

FIG. 2 illustrates a process flow diagram of one preferred plant facility according to the invention. This facility is designed to upgrade raw biogas, through the removal of CO₂ and other soluble gases, to produce primarily methane gas that is ideally clean and dry, and suitable for use as vehicle fuel.

With reference to FIG. 2 our overall system incorporates a gas compression system 1-2, a water scrubbing system 5, a flashing tank for gas recovery 6, a stripper vessel for regeneration of the process water 7 and a gas drying/purification system follows 8. Our preferred system is now discussed in detail.

The biogas passes from the inlet separator to suction of a stage one compressor 1 and is compressed to approximately 2.5 bar(g).

A water-cooled shell and tube intercooler cools the biogas after stage one compression. A check valve is installed between the stage one compressor discharge and intercooler to prevent reverse flow of biogas when the system is stopped.

A condensate collector pot at the discharge of the intercooler collects and removes condensate and compressor lube oil from the biogas. This collector pot also acts as a receiver for the flash gas recovered from the flashing tank 10

The biogas passes from the intercooler to suction of the stage two Compressor 2 and is compressed to approximately 9 bar(g).

Over pressure and over temperature protection devices are fitted on the stage two discharge.

A water-cooled shell and tube aftercooler cools the biogas after stage two compression. A check valve is installed between the stage two compressor discharge and aftercooler to prevent reverse flow of biogas when the system is stopped.

A condensate collector pot 11 at the discharge of the aftercooler collects and removes condensate and compressor lube oil from the biogas:

After the two stages of compression and cooling, the biogas enters the bottom of the scrubber vessel. 5 Our preferred scrubbing vessel incorporates a weir decant system (not shown) that skims off and removes the top layer of liquid in the scrubber 5 which may contain light hydrocarbon fractions, sulphur, fats and other contaminants. Inside the scrubber from 3, the biogas rises to the top, counter-flow to the process water flowing downwards. The water preferentially absorbs the undesirable gases such as CO₂ and H₂S, and product gas, which is now mainly CH₄, exits from the top of the scrubber. 30

Packing media and distributors inside the scrubber provide increased surface contact area between the gas and water, and maximise absorption efficiency.

The water discharged from the scrubber is saturated with dissolved CO₂, H₂S and a small amount of CH₄. It is necessary to regenerate the water by stripping it of these dissolved gases.

After being discharged from the scrubber, 4 the water is sent to the flashing tank 6. This tank 6 operates at an intermediate pressure. The pressure is lower than the scrubber pressure, but higher than the stripper pressure (and the stage one compressor discharge pressure). Inside the flashing tank 6, most of the CH₄ that was absorbed by the water in the scrubber is flashed off. This recovered flash gas is fed back into the stage one condensate collector pot 10. A back pressure regulating valve on the flash gas line regulates the pressure in the flashing tank.

The water discharged from the flashing tank is delivered to the top of the stripper vessel 7. After being cooled, the water is delivered to the top of the scrubber. A hold-up device and distributor at the top of the stripper ensures the water flows evenly down the stripper to maximise stripping efficiency.

Dissolved methane gas is removed in the flashing vessel 6. Water is regenerated by desorption of any remaining dissolved CO₂ gas in the stripping vessel 7. Water is re-pressurised and recirculated through the scrubber 5.

After the scrubber, 5 the water saturated product gas passes to a coalescing separator vessel (not shown) to remove free moisture.

After the coalescing separator vessel, the product gas passes through a PSA/TSA (Pressure Swing/Temperature Swing Adsorption) drier 8. Molecular sieve media in the drier columns adsorbs moisture and dries the product gas.

The drier is most preferably a vessel acting as a drying/purification system. Preferably this comprises of a Pressure Swing/Temperature Swing Adsorption (PSA/TSA) drier, which dries and further purifies the upgraded biogas after the scrubber, making it suitable for use as a vehicle fuel.

There most preferably the water saturated upgraded biogas from the scrubber 5 moves to a coalescing separator vessel (not shown) for removal of free moisture, then to the gas drying and H₂S removal system. A column of this system is as illustrated in FIG. 2. This regenerative drying/purification system uses dual columns. One column is always active, drying and purifying the product gas. The other column is regenerating or on standby. Each column has the capacity to be actively drying and purifying for approximately 8 hours under full load before requiring regeneration.

In the preferred embodiment regeneration is brought about by depressurising the column and then taking around 5% of the product methane, heating this gas stream and sending it back through the off-line column in a counter current direction.

The dried product gas passes through a filter and a back pressure control valve before being discharged. The filter traps any trace particles of molecular sieve media that may have been collected from the drier column. The control valve maintains a steady set pressure at the scrubber, thus ensuring consistent CO₂ and H₂S absorption.

The bio-methane product gas produced from the system consists of 97-98% CH₄, with H₂S of the order of parts per billion and dew point of less than −85° C.

### INDUSTRIAL APPLICATION

The method of the invention can be applied to biogas purification but also to other methane purification processes as would be envisaged by one skilled in the art.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A process for increasing the concentration of methane gas (CH₄) in a biogas stream comprising
i) wet scrubbing the biogas stream,
ii) drying the biogas stream (“upgraded biogas street”) by passage through a material able to remove water from the stream, and
iii) removing hydrogen sulphide (H₂S), or at least some of the H₂S, from the biogas stream by passage through activated carbon,
wherein the step of removal of the H₂S is subsequent to, and immediately follows, the drying step (ii).

2. The process of claim 1 wherein the drying of the biogas stream from step (i) comprises passage of the upgraded biogas stream through a porous material capable of removing water from the gas, and step (iii) removal of H₂S comprises passage of the upgraded biogas stream through activated carbon, wherein the porous material and the activated carbon are located in a single vessel and the drying and H₂S removal steps are carried out by passage of the upgraded biogas through this vessel.

3. The process of claim 2 wherein the porous material and the activated carbon are packed in a sequential fashion of porous material preceding the activated carbon in a single column (“the column”).

4. The process of claim 2 wherein the porous material comprises molecular sieves.

5. The process of claim 4 wherein the relative quantities of molecular sieves to activated carbon is selected so that regeneration of the molecular sieves is required at substantially the same or similar time to the activated carbon.

6. The process of claim 1 the wet scrubbing step (i) is a water scrubbing process in a water scrubber.

7. The process of claim 6 wherein the upgraded biogas stream exiting the water scrubber is at a temperature between 2-10° C.

8. The process of claim 3 wherein the upgraded biogas entering the column is at a temperature between 2-10° C. upon entry.

9. The process of claim 3 wherein upon exiting the column the H₂S levels of the upgraded biogas are in parts per billion.

10. The process of claim 3 wherein upon exiting the column the produced bio-methane meets a Swedish standard for biogas SS 15 54 38.

11. The process of claim 1 wherein at least step (ii) is at elevated pressure.

12. The process of claim 1 wherein steps (ii) and (iii) are performed in sequence in a single vessel of a bank of at least two such vessels and the stream is diverted from one vessel to the other vessel as the capacity of a vessel degrades in use.

13. An apparatus for increasing the CH₄ content of a stream of biogas comprising
a wet scrubber, and
a column, the column containing, in order of passage of the stream therethrough, a quantity of porous material capable of removing water from the stream, followed by a quantity of activated carbon.

14. The apparatus of claim 13 wherein the porous material comprises molecular sieves.

15. The apparatus of claim 14 wherein the relative quantities of molecular sieves to activated carbon is selected so that regeneration of the molecular sieves is required at substantially the same or similar time to the activated carbon.

16. The apparatus of claim 13 wherein the wet scrubber is a water scrubber.

17. The apparatus of claim 13 wherein the apparatus includes two substantially identical columns arranged in parallel, allowing one column to be on line whilst the other column is regenerated.

18. The apparatus of claim 17 wherein there are means to separate a fraction of the upgraded biogas exiting the on-line column, heating of that fraction of gas, and means for passage of that fraction of gas in a counter current direction through the column being regenerated.

19. The biogas enriched in methane and/or reduced in H₂S prepared according to a method of claim 1.

20. A column for increasing the CH₄ content and/or reducing the H₂S of a wet stream of biogas comprising a column packed sequentially with a gas dehydrating porous material followed by activated carbon.

21. The column of claim 20 wherein the dehydrating porous material is molecular sieves.

22. The column of claim 21 wherein the relative quantities of molecular sieves to activated carbon is selected so that regeneration of the molecular sieves is required at substantially the same or similar time to the activated carbon.
